(19) United States
(12) Patent Application Publication
(10) Pub. No.: US 2016/0379315 A1
(43) Pub. Date: Dec. 29, 2016

(54) METHODS AND SYSTEMS FOR OFFLINE PROCESSING OF TASKS

(71) Applicant: XEROX CORPORATION, Norwalk, CT (US)

(72) Inventors: Chithralekha Balamurugan, Pondicherry (IN); SARASCHANDRA KARANAM, Bangalore (IN); Sujit Gujar, Pune (IN); Neha Gupta, Chennai (IN)

(21) Appl. No.: 14/750,005

(22) Filed: Jun. 25, 2015

(51) Int. Cl. G06Q 50/00; G06Q 10/06

(52) U.S. Cl. CPC G06Q 50/01; G06Q 10/06311

(57) ABSTRACT

According to embodiments illustrated herein, there is provided a method for processing one or more tasks. The method includes monitoring a worker-computing device for at least security threats. The method further includes transmitting selected one or more tasks to the worker-computing device. Further a worker associated with the worker-computing device processes the one or more tasks, while the worker computing device is disconnected from the crowdsourcing platform. The method further includes monitoring the processing of the one or more tasks by the worker, while the worker computing device is disconnected from the crowdsourcing platform. The method further includes receiving responses for the one or more tasks from the worker computing device, while the worker-computing device is connected to the crowdsourcing platform.

### TECHNICAL FIELD

The presently disclosed embodiments are related, in general, to crowdsourcing. More particularly, the presently disclosed embodiments are related to methods and systems for offline processing of one or more tasks on a worker-computing device.

### BACKGROUND

Crowdsourcing is a process of obtaining needed services, ideas, or content by soliciting contributions from a large group of people, and especially from an online community, rather than from traditional employees or suppliers. This large group of people is commonly referred to as crowdworkers. Crowdsourcing may enable scaling of business processes by outsourcing to a wide and diverse crowd.

Usually, crowdsourcing provides an online job market over a crowdsourcing platform. Crowdworkers may connect to the crowdsourcing platform over a network and may process the one or more tasks posted by one or more requesters. To perform these tasks, the crowdworkers may have to remain connected to the crowdsourcing platform over the internet. Therefore, the cost of the internet usage may be an overhead for the crowdworkers. Further, the crowdworker may face intermittent internet connectivity issues if the crowdworker is traveling or if the user resides in a remote area. Such crowdworkers may not be able to perform tasks properly.

### SUMMARY

According to embodiments illustrated herein, there is provided a method for processing one or more tasks in a crowdsourcing platform. The method includes transmitting, by one or more processors, the one or more tasks to a worker computing device, wherein a worker associated with the worker computing device processes the one or more tasks, while the worker computing device is disconnected from the crowdsourcing platform. The method includes receiving, by the one or more processors, responses for the one or more tasks from the worker computing device, wherein the worker-computing device connects to the crowdsourcing platform for submitting the responses.

According to embodiments illustrated herein, there is provided a method for processing one or more tasks in a worker computing device. The method includes monitoring, by one or more processors, the worker computing device for at least security threats. The method includes receiving, by the one or more processors, the one or more tasks from a crowdsourcing platform based on the monitoring of the worker computing device, wherein the one or more tasks are processed by the worker on the worker computing device, while the worker computing device is disconnected from the crowdsourcing platform. The method includes monitoring, by the one or more processors, the processing of the one or more tasks by the worker. The method includes transmitting, by the one or more processors, responses for the one or more tasks to the crowdsourcing platform from the worker computing device based on the monitoring of the one or more tasks, wherein the worker computing device connects to the crowdsourcing platform for submitting the responses.

According to embodiments illustrated herein, there is provided a system for processing one or more tasks in a crowdsourcing platform. The system includes one or more processors configured to transmit the one or more tasks to a worker computing device, wherein a worker associated with the worker computing device processes the one or more tasks, while the worker computing device is disconnected from the crowdsourcing platform. The one or more processors are further configured to receive responses for the one or more tasks from the worker computing device, wherein the worker-computing device connects to the crowdsourcing platform for submitting the responses.

According to embodiments illustrated herein, there is provided a system for processing one or more tasks in a worker computing device. The system includes one or more processors configured to monitor the worker computing device for at least security threats. The one or more processors are further configured to receive the one or more tasks from a crowdsourcing platform based on the monitoring of the worker computing device, wherein the one or more tasks are processed by the worker on the worker computing device, while the worker computing device is disconnected from the crowdsourcing platform. The one or more processors are further configured to monitor the processing of the one or more tasks by the worker. The one or more processors are further configured to transmit the responses for the one or more tasks to the crowdsourcing platform from the worker computing device based on the monitoring of the one or more tasks, wherein the worker computing device connects to the crowdsourcing platform for submitting the responses.

According to embodiments illustrated herein, there is provided a computer program product for use with a computer. The computer program product includes a non-transitory computer readable medium. The non-transitory computer readable medium stores a computer program code for processing one or more tasks in a crowdsourcing platform. The computer program code is executable by one or more processors to transmit the one or more tasks to a worker computing device, wherein a worker associated with the worker computing device processes the one or more tasks, while the worker computing device is disconnected from the crowdsourcing platform. The computer program code is further executable by the one or more processors to receive responses for the one or more tasks from the worker computing device, wherein the worker computing device connects to the crowdsourcing platform for submitting the responses.

According to embodiments illustrated herein, there is provided a computer program product for use with a computer. The computer program product includes a non-transitory computer readable medium. The non-transitory computer readable medium stores a computer program code for processing one or more tasks in a worker computing device. The computer program code is executable by one or more processors to monitor the worker computing device for at least security threats. The computer program code is further executable by the one or more processors to receive the one or more tasks from a crowdsourcing platform based on the monitoring of the worker computing device, wherein the one or more tasks are processed by a worker on the worker computing device, while the worker computing device is disconnected from the crowdsourcing platform. The computer program code is further executable by the one or more processors to monitor the processing of the one or more tasks by the worker. The computer program code is further executable by the one or more processors to transmit responses for the one or more tasks to the crowdsourcing platform from the worker computing device based on the monitoring of the one or more tasks, wherein the worker computing device connects to the crowdsourcing platform for submitting the responses.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a message flow diagram illustrating a method for selecting, monitoring, and processing one or more tasks, in accordance with at least one embodiment;

FIG. 3 is a block diagram illustrating a crowdsourcing platform server for selecting and transmitting one or more tasks to a worker-computing device, in accordance with at least one embodiment;

FIG. 4 is a flowchart illustrating a method for selecting and transmitting one or more tasks to a worker-computing device, in accordance with at least one embodiment;

FIG. 5 is a block diagram illustrating a worker-computing device for processing one or more tasks, in accordance with at least one embodiment;

FIG. 6 is a flowchart illustrating a method for monitoring and processing of one or more tasks on a worker-computing device, in accordance with at least one embodiment; and

FIGS. 7A, 7B, 7C, and 7D illustrate example graphical user interfaces, which may be presented on a worker's computing device, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “computing device” refers to a device that includes one or more processors/microcontrollers and/or any other electronic components, or a device or a system which performs one or more operations according to one or more programming instructions/codes. Examples of the computing device may include, but are not limited to, a desktop computer, a laptop, a personal digital assistant (PDA), a mobile device, a smartphone, a tablet computer (e.g., iPad®, and Samsung Galaxy Tab®), and the like.

“Crowdsourcing” refers to the distribution of tasks and procurement of the needed services by soliciting the participation of defined groups of users. A group of users may include, for example, individuals responding to a solicitation posted on a certain website (e.g., crowdsourcing platform) such as Amazon Mechanical Turk or Crowd Flower.

A “crowdsourcing platform” refers to a business application, wherein a broad, loosely defined external group of workers, community, or organization provides solutions as the output for any specific business processes received by the application as the input. In an embodiment, the business application may be hosted online on a web portal. Various examples of the crowdsourcing platforms include, but are not limited to, Amazon Mechanical Turk and Crowd Flower.

A “crowdworker” refers to a worker or a group of workers who may perform one or more crowdsourcing tasks which generate data that contributes to a defined result, such as proofreading a part of a digital version of an ancient text or analyzing a small quantum of a large volume of data. In an embodiment, the crowdworkers may perform the one or more crowdsourcing tasks on a computing device that may be connected to a crowdsourcing platform over a network such as internet. The crowdworkers may utilize different devices and services to connect to the crowdsourcing platform. For example, a mobile internet, a data card, an internet dongle, a broadband, a wireless internet, hotspots, a dial-up connection, DSL (digital subscriber line), a satellite, ISDN (integrated services digital network), optical carrier, and T-carrier. Hereinafter, “worker”, “crowdsourced workforce”, “crowdworker”, “crowd workforce”, and “crowd” may be interchangeably used.

A “task” refers to a project, service, and/or job which may be performed by a crowdworker. A task may include instructions about how to perform the task. Further, a task may comprise features associated with the tasks. Examples of task features may include, but are not limited to, a day of submitting the task, a time in the day of submitting the task, a cost of the task, and so forth. Further, the task may comprise data which may be processed by the workers. The data may correspond to an image data or a text data in analog form and/or a digital form retained in at least one of an electronic form or a printed form. Each of the electronic form or the printed form may include one or more images, symbols, text, line art, blank, or non-printed regions, etc. In an embodiment, the electronic data may be obtained by scanning a corresponding printed document containing the electronic data. Further, the electronic data may be stored in various file formats such as, JPG or JPEG, GIF, TIFF, PNG, BMP, RAW, PSD, PSP, PDF, and the like. In an embodiment, the one or more tasks may comprise one or more of, but not limited to, data translation, data transcription, image tagging, article writing, website testing, data verification, logo design, business card design, ads, video, and website design.

A “requester” refers to a person and/or an organization who transmits one or more tasks, using a computing device, to a crowdsourcing platform for crowdsourcing. The crowdsourcing platform may transmit the one or more tasks to one or more workers.

A “first expiry time” refers to a time associated with a task, assigned or defined by a requester, in which the requestor expects the crowdsourcing platform to send the response.

A “second expiry time” refers to a time associated with a task, assigned or defined by a crowdsourcing platform, in which a worker is expected to submit the completed task. In an embodiment, the second expiry time associated with the task may be less than the first expiry time.

“Security threat” refers to a potential vulnerability of a computing device which may lead to a breach in security and thus cause a possible harm or leakage of confidential information associated with a task on/from the computing device (e.g., a worker's computing device).

“Working condition” refers to a condition in which an individual or worker works. In an embodiment, the working condition may include, but is not limited to, amenities, physical environment, preference criteria, stress and noise levels, degree of safety or danger, time and duration of availability for processing a task, and the like.

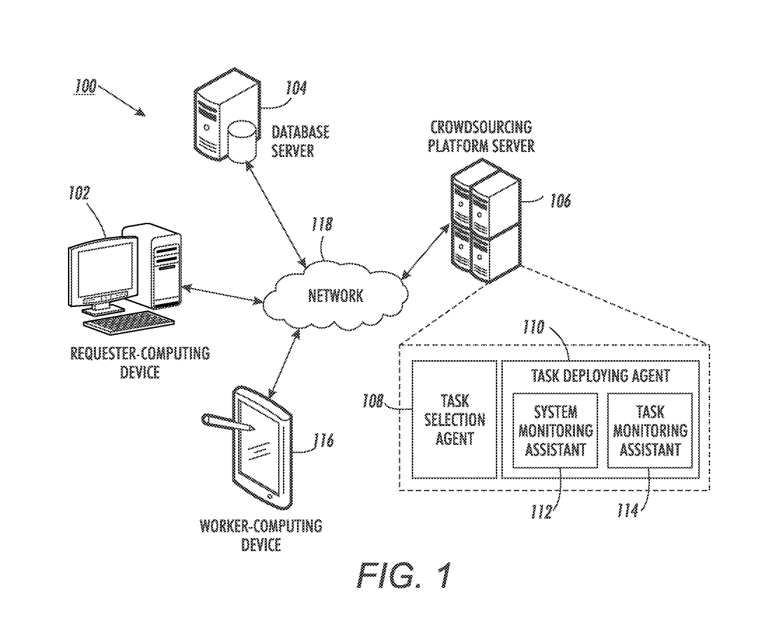

FIG. 1 is a block diagram illustrating a system environment 100 in which various embodiments may be implemented. The system environment 100 includes a requester-computing device 102, a database server 104, a crowdsourcing platform server 106, a worker-computing device 116, and a network 118. Various devices in the system environment 100 may be interconnected over the network 118. FIG. 1 shows, for simplicity, one requester-computing device 102, one database server 104, one crowdsourcing platform server 106, and one worker-computing device 116. However, it will be apparent to a person with ordinary skills in the art that the disclosed embodiments may also be implemented using multiple requester-computing devices 102, multiple database servers 104, multiple crowdsourcing platform servers 106, and multiple worker-computing devices 116.

The requester-computing device 102 refers to a computing device used by a requester. In an embodiment, the requester-computing device 102 may be communicatively coupled over the network 118. In an embodiment, the requester may utilize the requester-computing device 102 to transmit or receive information pertaining to one or more tasks to/from the crowdsourcing platform server 106 over the network 118. For example, if the crowdsourcing task corresponds to digitization of handwritten documents, the requester may transmit, using the requester-computing device 102, one or more electronic documents that include handwritten content. The information pertaining to the one or more tasks may comprise, but is not limited to, an expiry time associated with the one or more tasks and one or more instructions about how to perform the one or more tasks. In an embodiment, the requester may utilize the requester-computing device 102 to validate responses received for the one or more tasks. The requester-computing device 102 may correspond to various types of computing devices such as, but not limited to, a desktop computer, a laptop, a personal digital assistant (PDA), a mobile device, a smartphone, a tablet computer (e.g., iPad® and Samsung Galaxy Tab®), and the like.

The database server 104 may refer to a computing device which may store one or more tasks, in accordance with at least one embodiment. In an embodiment, the database server 104 may be communicatively coupled to the network 118. In an embodiment, the database server 104 may store one or more instructions/metadata/features pertaining to the one or more tasks. In an embodiment, the database server 104 may store profile of the one or more workers. The database server 104 may obtain the information pertaining to the profile of the one or more workers from various sources such as, but not limited to, crowdsourcing platforms and social networking websites. In an embodiment, the information pertaining to the profile of the one or more workers may comprise, but is not limited to, name, age, educational background, work history, employment details and/or worker's report card or performance data. In an embodiment, the worker's report card may include performance rating, number of successful and unsuccessful tasks, and other information pertaining to the one or more tasks processed by the one or more workers in the past. In an embodiment, the database server 104 may further store working conditions of the one or more workers (i.e. duration during which the one or more workers may be available). In an embodiment, the database server 104 may further store a task selection criteria for each of the one or more workers to select the one or more tasks (e.g., a particular type of task which crowdworker usually works on or processes). In an embodiment, the database server 104 may store responses of the one or more tasks submitted by the one or more workers. In an embodiment, the database server 104 may receive a query from the crowdsourcing platform server 106 to retrieve the metadata pertaining to the one or more tasks and/or information pertaining to the one or more workers. For querying the database server 104, one or more querying languages may be utilized such as, but not limited to, SQL, QUEL, DMX, and so forth. Further, the database server 104 may be realized through various technologies such as, but not limited to, Microsoft® SQL server, Oracle, and My SQL.

The crowdsourcing platform server 106 may refer to a computing device which may host one or more crowdsourcing platforms. In an embodiment, the one or more workers may be connected to the crowdsourcing platform server 106 over the network 118. In an embodiment, the crowdsourcing platform server 106 may send a query to the database server 104 to extract the one or more tasks and the metadata associated with the one or more tasks. In an embodiment, the crowdsourcing platform server 106 may receive the one or more tasks from the requester-computing device 102. In an embodiment, the one or more workers may logon to the crowdsourcing platform server 106 over the network 118 to select the one or more tasks. In an embodiment, the crowdsourcing platform server 106 may assign/distribute the one or more tasks to the one or more workers over the network 118. In an embodiment, the crowdsourcing platform server 106 may enable the offline processing of the selected one or more tasks by the worker on the worker-computing device 116. In an embodiment, the worker may submit the responses of the one or more tasks to the crowdsourcing platform over the network 118.

In an embodiment, the crowdsourcing platform server 106 may comprise a task selection agent 108 and a task deploying agent 110. In an embodiment, the one or more workers may utilize the task selection agent 108 to select the one or more tasks from the crowdsourcing platform over the network 118. In an embodiment, the task selection agent 108 may select the one or more tasks for the one or more workers based on the working condition and/or the task selection criteria of the one or more workers. In an embodiment, the task deploying agent 110 may transmit the selected one or more tasks from the crowdsourcing platform to the worker-computing device 116 over the network 118. In an embodiment, the task deploying agent 110 may enable the offline processing of the selected one or more tasks on the worker-computing device 116. In an embodiment, the task deploying agent 110 may comprise a system monitoring assistant 112 and a task monitoring assistant 114. In an embodiment, the system monitoring assistant 112 may monitor the worker-computing device 116. In an embodiment, the system monitoring assistant 112 may be operable to check whether the worker-computing device 116 has the required resources so that the worker may process the one or more tasks on the worker-computing device 116, while the worker-computing device 116 is disconnected from the crowdsourcing platform. In an embodiment, the system monitoring assistant 112 may be operable to check any security threats on the worker-computing device 116. In an embodiment, the task monitoring assistant 114 may be sent/transmitted along with the selected one or more tasks to the worker-computing device 116 over the network 118. In an embodiment, the task monitoring assistant 114 may monitor the processing of the one or more tasks on the worker-computing device 116, while the worker-computing device 116 is disconnected from the crowdsourcing platform server 106. In an embodiment, the task monitoring assistant 114 may correspond to a plugin that may be installed on the worker computing device 116 to monitor the processing of the one or more tasks.

In an embodiment, the crowdsourcing platform server 106 may comprise a master controller (not shown). In an embodiment, the master controller may control and monitor the operation of the task selection agent 108 and the task deploying agent 110. In an embodiment, the master controller may monitor the pre-expiry time or the second expiry time of the one or more tasks, while the crowdsourcing platform is disconnected from the worker-computing device 116.

In an embodiment, the crowdsourcing platform server 106 may present a graphical user interface (GUI) to the one or more workers through a web-based interface or a client application installed on the worker-computing device 116. In an embodiment, the crowdsourcing platform server 106 may itself host the application to create the one or more tasks and sub-tasks. The crowdsourcing platform server 106 may be realized through an application server such as, but not limited to, Java application server, .NET framework, Base4 application server, and Appaserver.

A person skilled in the art would understand that the scope of the disclosure should not be limited to the database server 104 or the crowdsourcing platform server 106 as a separate entity. In an embodiment, one or more functionalities of the database server 104, and/or the crowdsourcing platform server 106 may be combined into a single server, without limiting the scope of the invention. In an alternate embodiment, the one or more functionalities of the database server 104 may be integrated into the crowdsourcing platform server 106.

The worker-computing device 116 may refer to a computing device used by the worker. The worker-computing device 116 may enable the worker to process/work upon the selected/assigned one or more tasks. In an embodiment, the worker-computing device 116 may be communicatively coupled over the network 118. In an embodiment, the worker may utilize the worker-computing device 116 to select the one or more tasks from the crowdsourcing platform over the network 118 using the task selection agent 108. The worker may utilize different devices and services to connect to the crowdsourcing platform. For example, a mobile internet, a data card, an internet dongle, a broadband, a wireless internet, hotspots, a dial-up connection, DSL (digital subscriber line), a satellite, ISDN (integrated services digital network), optical carrier, and T-carrier. In an embodiment, the worker may utilize the worker-computing device 116 to process the selected one or more tasks, while the worker-computing device 116 is disconnected from the crowdsourcing platform server 106. In an embodiment, the worker may utilize the worker-computing device 116 to submit the responses of the one or more tasks to the crowdsourcing platform over the network 118. The worker may utilize the worker-computing device 116 to submit the responses using the web interface (provided by the crowdsourcing platform server 106) or using the client application, as discussed above. The worker-computing device 116 may include various types of computing devices such as, but not limited to, a desktop computer, a laptop, a personal digital assistant (PDA), a mobile device, a smartphone, a tablet computer (e.g., iPad® and Samsung Galaxy Tab®), and the like.

The network 118 corresponds to a medium through which content and messages may flow between one or more of, but not limited to, the requester-computing device 102, the database server 104, the crowdsourcing platform server 106, and/or the worker-computing device 116. Examples of the network 118 may include, but are not limited to, a Wireless Fidelity (Wi-Fi) network, a Wide Area Network (WAN), a Local Area Network (LAN), or a Metropolitan Area Network (MAN). Various devices such as the requester-computing device 102, the database server 104, the crowdsourcing platform server 106, and/or the worker-computing device 116 may connect to the network 118 in accordance with various wired and wireless communication protocols such as Transmission Control Protocol/Internet Protocol (TCP/IP), User Datagram Protocol (UDP), and 2G, 3G, or 4G communication protocols. Further, various devices such as the requester-computing device 102, the database server 104, the crowdsourcing platform server 106, and/or the worker-computing device 116 may connect to the network 118 by utilizing different devices and services such as, but not limited to, a mobile internet, a data card, an internet dongle, a broadband, a wireless internet, hotspots, a dial-up connection, DSL (digital subscriber line), a satellite, ISDN (integrated services digital network), optical carrier, and T-carrier.

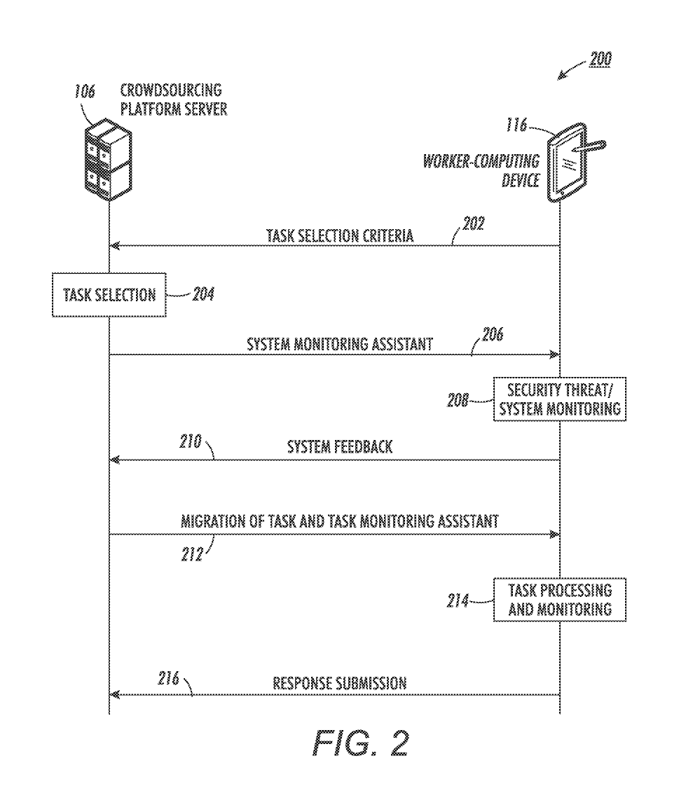

FIG. 2 is a message flow diagram 200 illustrating a method for selecting, monitoring, and processing one or more tasks, in accordance with at least one embodiment. The message flow diagram 200 shows interaction between the crowdsourcing platform server 106 and the worker-computing device 116 of FIG. 1.

In an embodiment, a worker may utilize the worker-computing device 116 to transmit the task selection criteria to the crowdsourcing platform (depicted by 202). In an embodiment, the worker may transmit the task selection criteria from the worker-computing device 116 to the crowdsourcing platform server 106 over the network 118. The task selection criteria may comprise one or more criteria for selecting the one or more tasks from the crowdsourcing platform. In an embodiment, the one or more criteria may include, but are not limited to, type of tasks, requester, recent tasks, and/or payment. In an embodiment, the task selection criteria may also comprise the working condition of the worker. The working condition may comprise, but is not limited to, time and duration available to process the one or more tasks by the worker.

In an embodiment, the worker may further define a recurrence criteria. In an embodiment, the recurrence criteria corresponds to a time duration or time period during the course of the day, in which the worker may accept recurring tasks from the crowdsourcing platform. In an embodiment, the recurring tasks correspond to tasks which are continuously sent to the worker on completion of the previous tasks allocated to the worker. For example, if the worker completes a task A, the crowdsourcing platform may automatically send task B to the worker.

In an embodiment, the task selection agent 108 (in the crowdsourcing platform server 106) may select the one or more tasks based on the task selection criteria (depicted by 204). In an alternate embodiment, the task selection agent 108 may display the one or more tasks to the worker (associated with the worker-computing device 116) over the graphical user interface. In such a case, the worker may provide input to select the one or more tasks. In an embodiment, the worker-computing device 116 is in connection with the crowdsourcing platform server 106 during the selection of the one or more tasks.

In an embodiment, the crowdsourcing platform server 106 may give suggestion to the worker about the selected one or more tasks by the task selection agent 108 on the worker-computing device 116 over the network 118. In such a scenario, the worker may select the one or more tasks of his/her choice over the network 118. In an embodiment, the task selection agent 108 may allow the worker to select the suggested one or more tasks for processing. In an embodiment, the one or more tasks selected by the worker may be unavailable for other workers. In an embodiment, the one or more tasks selected by the worker may be available for other workers, when the requester wants the processing of the one or more tasks by multiple workers. In an embodiment, the task selection agent 108 may transmit the selected one or more tasks to the task deploying agent 110.

In an embodiment, the crowdsourcing platform server 106 may transmit the system monitoring assistant 112 to the worker-computing device 116 (depicted by 206). The system monitoring assistant 112 may be operable to monitor the worker-computing device 116 (depicted by 208). In an embodiment, the system monitoring assistant 112 may monitor the resources available in the worker-computing device 116 to determine whether the available resources on the worker-computing device 116 are in accordance with the resources required to process the one or more tasks on the worker-computing device 116. In an embodiment, the system monitoring assistant 112 may be operable to check for any security threats on the worker-computing device 116.

In an embodiment, the system monitoring assistant 112 (on the worker-computing device 116) transmits system feedback report to the crowdsourcing platform server 106 (depicted by 210). In an embodiment, the feedback report may either be a positive feedback or a negative feedback report. The system monitoring assistant 112 may transmit the positive feedback report, when the worker-computing device 116 meets the system requirement and does not pose any security threats. The system monitoring assistant 112 may transmit the negative feedback report, when the worker-computing device 116 is infected (i.e., pose a security threat) and/or is unable to meet the system requirement.

In an embodiment, the task deploying agent 110 (in the crowdsourcing platform server 106) transmits the selected one or more tasks and the task monitoring assistant 114 to the worker-computing device 116 (depicted by 212). In an embodiment, the task deploying agent 110 may transmit the selected one or more tasks and/or the task monitoring assistant 114 to the worker-computing device 116, when the worker-computing device 116 is connected to the crowdsourcing platform server 106 over the network 118. In an embodiment, the task deploying agent 110 may transmit the selected one or more tasks and/or the task monitoring assistant 114 to the worker-computing device 116 over the network 118, when the system monitoring assistant 112 transmits a positive feedback report about the worker-computing device 116. The transmitted one or more tasks may have an associated first expiry time and a second expiry time. The second expiry time associated with the one or more tasks may be less than the first expiry time. In an embodiment, the second expiry time corresponds to a time assigned or defined by the requester, in which the worker is expected to submit the completed task. In an embodiment, the first expiry time corresponds to a time assigned or defined by the requester, after which the task may expire on the crowdsourcing platform. In an embodiment, the crowdsourcing platform server 106 may utilize a pre-stored instruction to define the second expiry time of the one or more tasks. For example, as per the pre-stored instruction, the crowdsourcing platform may set the second expiry time of a task as 60 percent of the first expiry time of the task. In an embodiment, the crowdsourcing platform server 106 may utilize a timer to keep a check on the first expiry time and the second expiry time associated with the one or more tasks.

Post receiving the selected one or more tasks on the worker-computing device 116 over the network 118, the worker-computing device 116 may disconnect from the crowdsourcing platform server 106 after the reception of the selected one or more tasks and/or the task monitoring assistant 114 on the worker-computing device 116.

Post receiving the one or more tasks, the worker may process the one or more tasks on the worker-computing device 116 (depicted by 214), while the worker-computing device 116 may be disconnected from the crowdsourcing platform server 106. In an embodiment, the disconnection of the worker-computing device 116 from the crowdsourcing platform server 106 may imply that the worker-computing device 116 may not be connected to the crowdsourcing platform server 106 over the network 118. In an embodiment, the task monitoring assistant 114 (on the worker-computing device 116) may monitor the offline processing of the one or more tasks by the worker on the worker-computing device 116 (depicted by 214). The task monitoring assistant 114 may keep a record of a time spent by the worker on the processing of the one or more tasks. The task monitoring assistant 114 may monitor the second expiry time associated with the one or more tasks, in which the worker may have to submit the responses of the one or more tasks to the crowdsourcing platform. Further, the task monitoring assistant 114 may keep a count of the number of tasks processed by the worker.

Post completing the processing of the received one or more tasks, the worker may submit the responses for the one or more tasks to the crowdsourcing platform (depicted by 216). Prior to submitting the response, the worker-computing device 116 may connect to the crowdsourcing platform server 106 over the network 118. Thereafter, the worker may submit the responses of the one or more tasks to crowdsourcing platform through the worker-computing device 116.

In a scenario, where the second expiry time expires, the task deploying agent 110 may stop the processing of the one or more tasks on the worker-computing device 116.

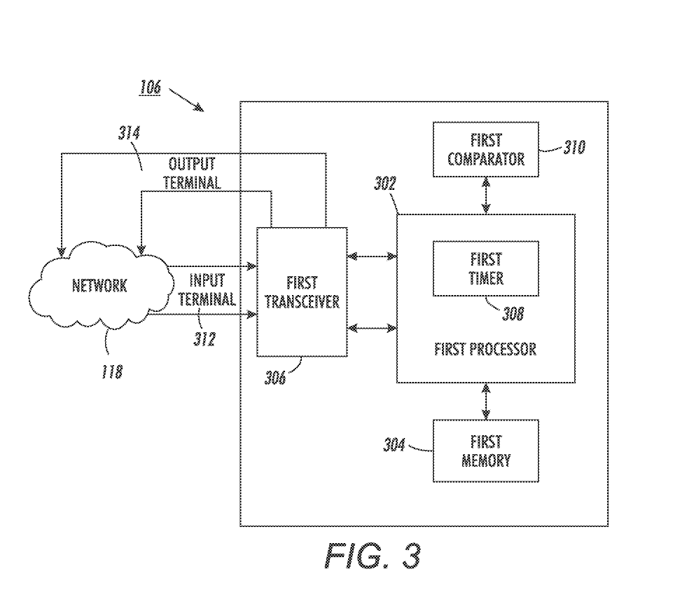

FIG. 3 is a block diagram illustrating a crowdsourcing platform server 106 for selecting and transmitting the one or more tasks to the worker-computing device 116, in accordance with at least one embodiment. The crowdsourcing platform server 106 may comprise one or more processors, such as a first processor 302, one or more memories, such as a first memory 304, one or more transceivers, such as a first transceiver 306, one or more timers, such as a first timer 308, and one or more comparators, such as a first comparator 310. The first processor 302 is coupled to the first memory 304, the first transceiver 306, the first timer 308, and the first comparator 310. The first transceiver 306 is connected to the network 118 through an input terminal 312 and an output terminal 314.

The first processor 302 may be operable to execute a set of instructions stored in the first memory 304. The first processor 302 may be coupled to the first memory 304, the first transceiver 306, and the first comparator 310. The first processor 302 may execute a set of instructions/programs/software applications stored in the first memory 304 to perform one or more operations. The first processor 302 may comprise a first timer to keep a track of time associated with one or more tasks. The first processor 302 may be implemented based on a number of processor technologies known in the art. Examples of the first processor 302 include, but are not limited to, an X86-based processor, a Reduced Instruction Set Computing (RISC) processor, an Application-Specific Integrated Circuit (ASIC) processor, and/or a Complex Instruction Set Computing (CISC) processor.

The first memory 304 may be operable to store one or more machine codes, software applications, and/or computer programs having at least one code section executable by the first processor 302. The first memory 304 may store one or more sets of instructions and data. Some of the commonly known memory implementations include, but are not limited to, a random access memory (RAM), a read only memory (ROM), a hard disk drive (HDD), and a secure digital (SD) card. In an embodiment, the first memory 304 may include the one or more machine codes, and/or computer programs which are executable by the first processor 302 to perform specific operations. It will be apparent to a person with ordinary skills in the art that the one or more instructions/software applications stored in the first memory 304 enables the hardware of the crowdsourcing platform server 106 to perform the predetermined operation.

The first transceiver 306 may be operable to communicate with the one or more devices, such as the requester-computing device 102 worker-computing device 116, and/or one or more servers, such as the database server 104 over the network 118. The first transceiver 306 is coupled to the input terminal 312 and the output terminal 314 through which the first transceiver 306 may receive and transmit data/messages, respectively. Examples of the first transceiver 306 may include, but are not limited to, an antenna, an Ethernet port, an USB port or any other port which can be configured to receive and transmit data. The first transceiver 306 may receive and transmit data/messages in accordance with various communication protocols such as, TCP/IP, UDP, and 2G, 3G, or 4G communication protocols through the input terminal 312 and the output terminal 314.

The first timer 308 may be operable to keep a track of the time associated with processing of the one or more tasks. In an embodiment, the first timer 308 may be a software timer or a hardware timer. In an embodiment, the first processor 302 may include a dedicated hardware timer which may be accessed by using one or more instructions. In an embodiment, the first timer 308 may be implemented using one or more known techniques of digital electronics. The first timer 308 may be implemented using software techniques such as a programmable logic controller.

The first comparator 310 is configured to compare at least two input signals to generate an output signal. In an embodiment, the output signal may correspond to either “1” or “0”. In an embodiment, the first comparator 310 may generate the output “1” if the value of a first signal (from at least two signals) is greater than a value of the second signal (from the at least two signals). Similarly, the first comparator 310 may generate an output “0” if the value of the first signal is less than the value of the second signal. In an embodiment, the first comparator 310 may be realized through either software technologies or hardware technologies known in the art. Though, the first comparator 310 is shown outside the first processor 302 in FIG. 3, a person skilled in the art would appreciate that the first comparator 310 may be implemented inside the first processor 302 without departing from the scope of the disclosure.

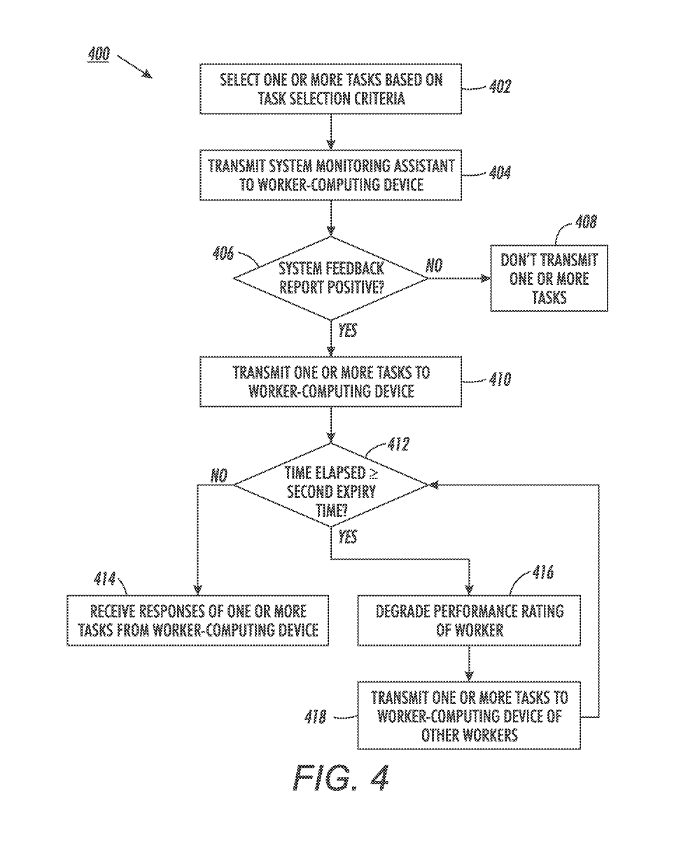

FIG. 4 is a flowchart 400 illustrating a method for selecting and transmitting the one or more tasks on to the worker-computing device 116, in accordance with at least one embodiment. The flowchart 400 is described in conjunction with FIG. 1, FIG. 2, and FIG. 3.

At step 402, the one or more tasks are selected based on the task selection criteria. In an embodiment, the first processor 302 may utilize the task selection agent 108 to select the one or more tasks for the one or more workers based on the pre-defined task selection criteria. The first memory 304 may store the task selection criteria for each of the one or more workers. In an embodiment, the worker may utilize the task selection agent 108 to select the one or more tasks over the network 118. In an embodiment, the one or more tasks may be selected based on the industry/requester/payment/time duration associated with the one or more tasks. For example, there are two tasks such as a first task from industry A and a second task from industry B. The payment associated with the first task is USD 5 and the payment associated with the second task is USD 4. The task selection agent 108 will select the first task for a worker A, if the worker A is interested in one or more tasks from industry A. However, if the worker A is interested in one or more tasks with payments more than USD 3, then in such a case, the task selection agent 108 will select both tasks (first tasks and second task) for the worker A. In an embodiment, the one or more tasks may be selected based on the time available with the worker for processing the one or more tasks. For example, the first task requires 5 hours of effort and the second task needs 9 hours of effort and both the tasks should be completed within two days. However, the worker A has only 7 hours available in next two days. In such a scenario, the task selection agent 108 will select the first task for the worker A.

At step 404, the system monitoring assistant 112 is transmitted to the worker-computing device 116. In an embodiment, the first processor 302 may transmit the system monitoring assistant 112 from the crowdsourcing platform to the worker-computing device 116 over the network 118. In an embodiment, the system monitoring assistant 112 may be an application software which may be transmitted to the worker-computing device 116 to monitor the resources available in the worker-computing device 116 to determine if the available resources on the worker-computing device 116 are in accordance with the required resources to process the one or more tasks on the worker-computing device 116. For example, an image processing task requires that the worker-computing device 116 should have Adobe Photoshop™ installed, therefore the system monitoring assistant 112 may check the worker-computing device 116 to check whether Adobe Photoshop™ is installed on the worker-computing device 116. In an embodiment, the system monitoring assistant 112 may be operable to check for any security threats on the worker-computing device 116. In an embodiment, a feedback report generated by the system monitoring assistant 112 (transmitted to the worker-computing device 116) may be positive or negative. For instance, if the system monitoring assistant 112 detects a virus or malware, the system monitoring assistant 112 may generate a negative feedback and vice versa.

At step 406, a check is performed to determine if the system feedback report is positive. In an embodiment, the first processor 302 may monitor the system feedback report of the worker-computing device 116. If at step 406, it is determined that the system feedback report is negative, then step 408 is performed. If at step 406, it is determined that the system feedback report is positive, then step 410 is performed.

At step 408, the one or more tasks are not transmitted. In an embodiment, the first processor 302 may not transmit the one or more tasks to the worker-computing device 116, when the first processor 302 determines that the system feedback report of the worker-computing device is negative.

At step 410, the one or more tasks are transmitted to the worker-computing device 116. In an embodiment, the first processor 302 may transmit the selected one or more tasks to the worker-computing device 116 over the network 118. In an embodiment, the first processor 302 may further transmit the task monitoring assistant 114 along with the selected one or more tasks to the worker-computing device 116 over the network 118. In an embodiment, the first processor 302 may utilize a timer (e.g., the first timer 308) to monitor the first expiry time and the second expiry time associated with transmitted one or more tasks.

At step 412, a check is performed to determine whether the time elapsed since the transmission of the one or more tasks is greater than or equal to the second expiry time associated with the transmitted one or more tasks. In an embodiment, the first processor 302 may utilize the first timer 308 to monitor the elapsed time of the transmitted one or more tasks. The first processor 302 may utilize the first comparator 310 to compare the elapsed time and the second expiry time associated with the transmitted one or more tasks. If at step 412, it is determined that the elapsed time is less than the second expiry time, then the first processor may wait for the response and step 414 is performed. If at step 412, it is determined that the elapsed time is greater than or equal to the second expiry time, then the task deploying agent 110 may stop the worker from processing the one or more tasks on the worker-computing device 116 and step 416 is performed.

At step 414, the responses of the transmitted one or more tasks are received. In an embodiment, the first processor 302 may receive the responses of the transmitted one or more tasks from the worker-computing device 116 over the network 118. The first processor 302 may accept the responses of the transmitted one or more tasks when the responses are free from any security threats.

Post receiving the responses, the first processor 302 may transmit one or more additional tasks to the worker-computing device 116 over the network 118 if the worker has opted for the recurrence of the one or more tasks.

At step 416, the performance rating of the worker is degraded. In an embodiment, the first processor 302 may degrade the performance rating of the worker, when the worker fails to submit the responses of the transmitted one or more tasks before the second expiry time. In such a scenario, the first processor 302 may restrict the worker from working on the crowdsourcing platform for a certain time period. In another scenario, the first processor 302 and/or the requester may restrict the worker from working on the one or more tasks posted by the requester.

At step 418, the one or more tasks are transmitted to the worker-computing device 116 of the other workers. In an embodiment, the first processor 302 may transmit the one or more tasks to the worker-computing device 116 of other workers over the network 118, when the worker fails to submit the responses of the one or more transmitted tasks within the second expiry time associate with the transmitted tasks. In such a scenario, the first processor 302 may define a fresh second expiry time for the one or more tasks. In an embodiment, the requester may define the fresh second expiry time for the one or more tasks. In an embodiment, the first processor 302 may utilize the task deploying agent 110 to transmit the one or more tasks to the worker-computing device 116 of other workers.

A person having ordinary skills in the art would understand that the first processor 302 may divide the time period between a time instance, at which the one or more tasks were received by the crowdsourcing platform, and the first expiry time, in or more time slots. In an embodiment, the one or more time slots may correspond to a time duration allocated to the one or more workers to complete the one or more tasks. For example, the crowdsourcing platform server may receive a task at 1:00 PM. The first expiry time of the task is 4 hours. The crowdsourcing platform server may divide the 4 hours' time-duration into four time slots each of duration 1 hour. The crowdsourcing platform server 106 may allocate 1 hour to a worker as the second expiry time.

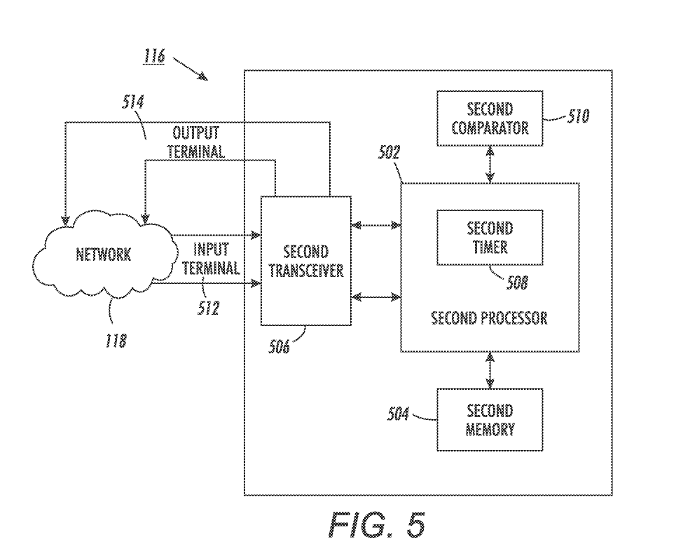

FIG. 5 is a block diagram illustrating a worker-computing device 116 for processing the one or more tasks, in accordance with at least one embodiment. The worker-computing device 116 may comprise one or more processors, such as a second processor 502, one or more memories, such as a second memory 504, one or more transceivers, such as a second transceiver 506, one or more timers, such as a second timer 508, and one or more comparators, such as a second comparator 510. The second processor 502 is coupled to the second memory 504, the second transceiver 506, the second timer 508, and the second comparator 510. The second transceiver 506 is connected to the network 118 through an input terminal 512 and an output terminal 514.

The second processor 502 may be operable to execute a set of instructions stored in the second memory 504. The second processor 502 may be coupled to the second memory 504 and the second transceiver 506. The second processor 502 may execute a set of instructions/programs/application software stored in the second memory 504 to perform one or more operations. The second processor 502 may be implemented based on a number of processor technologies known in the art. Examples of the second processor 502 include, but are not limited to, an X86-based processor, a RISC processor, an ASIC processor, and/or a CISC processor.

The second memory 504 may be operable to store one or more machine codes, application software, and/or computer programs having at least one code section executable by the second processor 502. The second memory 504 may store one or more sets of instructions and data. Some of the commonly known memory implementations include, but are not limited to, a random access memory (RAM), a read only memory (ROM), a hard disk drive (HDD), and a secure digital (SD) card. In an embodiment, the second memory 504 may include the one or more machine codes, and/or computer programs which are executable by the second processor 502 to perform specific operations. It will be apparent to a person having ordinary skills in the art that the one or more instructions stored in the second memory 504 enables the hardware of the worker-computing device 116 to perform the predetermined operation.

The second transceiver 506 may be operable to communicate with the one or more devices, such as the requester-computing device 102, and/or one or more servers, such as the crowdsourcing platform server 106 over the network 118. The second transceiver 506 is coupled to the input terminal 512 and the output terminal 514 through which the second transceiver 506 may receive and transmit data/messages, respectively. Examples of the second transceiver 506 may include, but are not limited to, an antenna, an Ethernet port, an USB port or any other port which can be configured to receive and transmit data. The second transceiver 506 may receive and transmit data/messages in accordance with various communication protocols such as, TCP/IP, UDP, and 2G, 3G, or 4G communication protocols through the input terminal 512 and the output terminal 514.

The second timer 508 may be operable to keep a track of the time associated with the processing of the one or more tasks. In an embodiment, the second timer 508 may be a software timer or a hardware timer. In an embodiment, the second processor 502 may include a dedicated hardware timer which may be accessed by using one or more instructions. In an embodiment, the second timer 508 may be implemented using one or more known techniques of digital electronics. The second timer 508 may be implemented using software techniques such as a programmable logic controller.

The second comparator 510 is configured to compare at least two input signals to generate an output signal. In an embodiment, the output signal may correspond to either “1” or “0”. In an embodiment, the second comparator 510 may generate the output “1” if the value of a first signal (from the at least two signals) is greater than a value of the second signal (from the at least two signals). Similarly, the second comparator 510 may generate an output “0” if the value of the first signal is less than the value of the second signal. In an embodiment, the second comparator 510 may be realized through either software technologies or hardware technologies known in the art. Though, the second comparator 510 is shown outside the second processor 502 in FIG. 5, a person skilled in the art would appreciate that the second comparator 510 may be implemented inside the second processor 502 without departing from the scope of the disclosure.

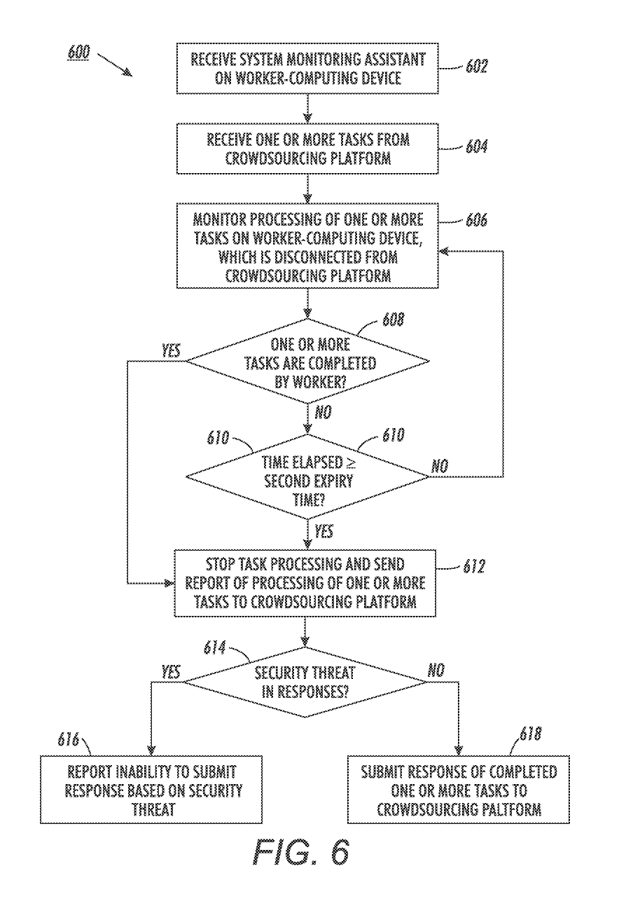

FIG. 6 is a flowchart 600 illustrating a method to monitor and process the one or more tasks on the worker-computing device 116, in accordance with at least one embodiment. The flowchart 600 is described in conjunction with FIG. 1, FIG. 2, FIG. 3, FIG. 4, and FIG. 5.

At step 602, the system monitoring assistant 112 is received on the worker-computing device. In an embodiment, the second processor 502 may receive the system monitoring assistant 112 on the worker-computing device 116 over the network 118. The system monitoring assistant 112 may be operable to monitor the worker-computing device 116 for the resources required on the worker-computing device 116 for processing the one or more tasks. The system monitoring assistant 112 may check the worker-computing device 116 for any security threats. In an embodiment, the second processor 502 may transmit the system feedback report to the first processor 302 and/or the task deploying agent 110 of the crowdsourcing platform over the network 118.

At step 604, the transmitted one or more tasks are received. In an embodiment, the second processor 502 may receive the transmitted one or more tasks from the crowdsourcing platform over the network 118. In an embodiment, the second processor 502 may receive the task monitoring assistant 114 from the crowdsourcing platform. The task monitoring assistant 114 may be operable to monitor the processing of the received one or more tasks on the worker-computing device 116, while the worker-computing device 116 is disconnected from the crowdsourcing platform server 106, i.e., the worker-computing device 116 may not be connected over the network 118. In an embodiment, the worker may disconnect the worker-computing device 116 from the crowdsourcing platform, when the second processor 502 may have received the one or more tasks.

At step 606, the processing of the received one or more tasks is monitored. In an embodiment, the second processor 502 may utilize the task monitoring assistant 114 to monitor the processing of the received one or more tasks on the worker-computing device 116. In an embodiment, the worker may process the received one or more tasks on the worker-computing device 116, while the worker-computing device 116 is disconnected from the crowdsourcing platform server 106. In an embodiment, the disconnection of the worker-computing device 116 from the crowdsourcing platform server 106 may imply that the worker-computing device 116 may not be connected to the crowdsourcing platform server 106 over the network 118. The task monitoring assistant 114 monitors the processing of the received one or more tasks on the worker-computing device 116, while the worker-computing device 116 is disconnected from the crowdsourcing platform server 106. In an embodiment, the task monitoring assistant 114 may utilize the second timer 508 to monitor the time spent by the worker on the processing of the received one or more tasks on the worker-computing device 116. In another embodiment, the second timer 508 may display the available time to complete the one or more tasks. In an embodiment, the task monitoring assistant 114 may monitor the second expiry time associated with the received one or more tasks by which the worker may have to submit the responses of the received one or more tasks. The task monitoring assistant 114 may keep a record of the number of tasks processed by the worker, while the worker-computing device 116 is disconnected from the crowdsourcing platform over the network 118.

At step 608, a check is performed to determine whether the worker has completed the received one or more tasks. In an embodiment, the second processor 502 may utilize the task monitoring assistant 114 to determine if the worker has completed the processing of the received one or more tasks. If at step 608, it is determined that the worker has not completed the received one or more tasks, then the second processor 502 may check the second expiry time and step 610 is performed. If at step 608, it is determined that the worker has completed the received one or more tasks, then the worker and/or the second processor 502 may submit the responses of the one or more tasks and step 612 is performed.

At step 610, a check is performed to determine if the time elapsed since the reception of the one or more tasks is greater than or equal to the second expiry time of the received one or more tasks. In an embodiment, the second processor 502 may utilize the task monitoring assistant 114 to keep a check on the elapsed time of the received one or more tasks while the worker is processing the received one or more tasks on the worker-computing device 116. In an embodiment, the second comparator 510 may compare the elapsed time of the received one or more tasks to the second expiry time of the received one or more tasks. If at step 610, it is determined that the elapsed time is less than the second expiry time of the received one or more tasks, then the second processor 502 may continue monitoring the processing of the one or more tasks and step 606 is performed. If at step 610, it is determined that the elapsed time is greater than or equal to the second expiry time of the received one or more tasks, then the second processor 502 may stop the processing of the one or more tasks on the worker-computing device 116 and step 612 is performed.

At step 612, the processing of the received one or more tasks on the worker-computing device are stopped. In an embodiment, the second processor 502 may stop the processing of the received one or more tasks on the worker-computing device 116. In an embodiment, the second processor 502 may stop the monitoring of the received one or more tasks on the worker-computing device 116, when the worker may have completed the processing of the received one or more tasks before the second expiry time associated with the received one or more tasks. In an embodiment, the second processor 502 may stop the processing of the received one or more tasks on the worker-computing device 116 if the worker has not completed the processing of the one or more tasks before the second expiry time associated with the received one or more tasks. In an embodiment, the second processor 502 may transmit the responses of the completed one or more tasks and/or the processing report of the worker to the crowdsourcing platform, when the worker-computing device 116 is connected with the crowdsourcing platform server 106 over the network 118. The worker may utilize different devices and services to connect to the crowdsourcing platform such as, but not limited to, a mobile internet, a data card, an internet dongle, a broadband, a wireless internet, hotspots, a dial-up connection, DSL (digital subscriber line), a satellite, ISDN (integrated services digital network), optical carrier, and T-carrier.

At step 614, a check is performed to determine if any security threat is present in the responses of the completed one or more tasks. In an embodiment, the second processor 502 may utilize the system monitoring assistant 112 to check for any security threat in the responses of the completed (partially or fully) one or more tasks before submitting the responses to the crowdsourcing platform over the network 118. If at step 614, it is determined that the responses are infected, the second processor 502 may not submit the responses of the completed (partially or fully) one or more tasks, and thus step 616 is performed. If at step 614, it is determined that the responses of the completed (partially or fully) one or more tasks are not infected, then step 618 is performed.

At step 616, the inability to submit the responses of the completed (partially or fully) one or more tasks is reported. In an embodiment, the second processor 502 may report the inability to submit the responses of the completed (partially or fully) one or more tasks due to the security threat in the responses of the completed (partially or fully) one or more tasks. In such a case, the second processor 502 may not submit the responses of the one or more tasks but may convey the status of processing so that the crowdsourcing platform may not degrade the worker's performance rating due to non-submission of the responses on time.

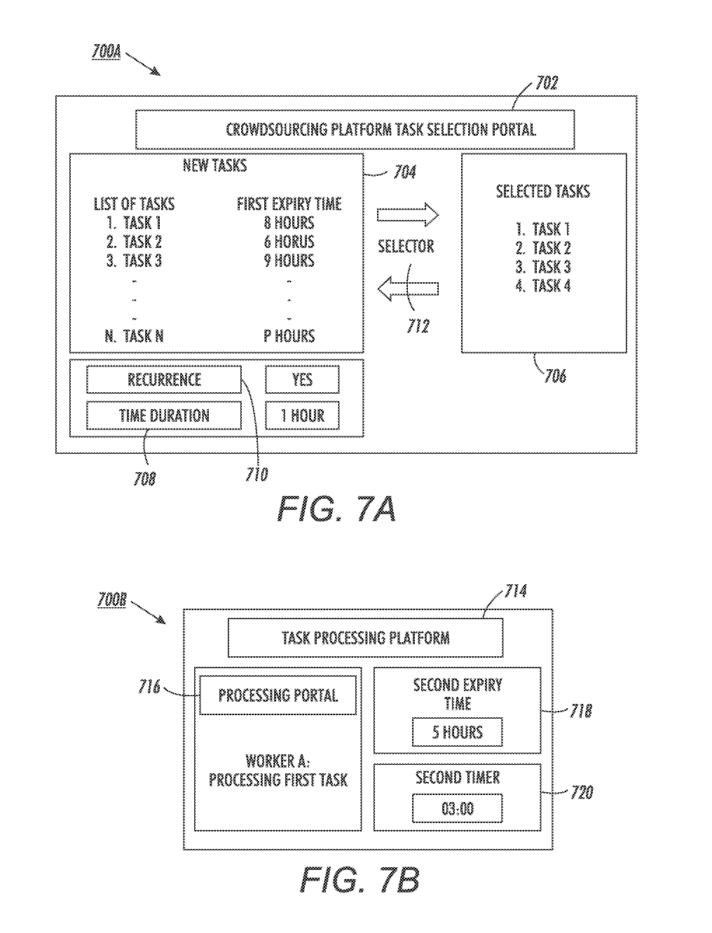

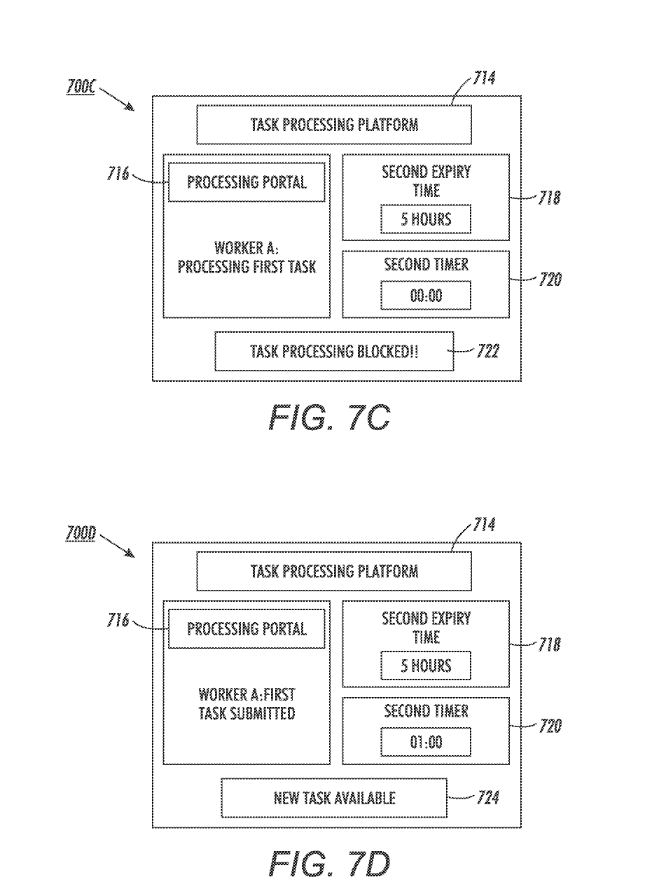

At step 618, the responses of the completed (partially or fully) one or more tasks are submitted to the crowdsourcing platform. In an embodiment, the second processor 502 may submit the responses of the completed (partially or fully) one or more tasks to the crowdsourcing platform, when the worker-computing device 116 is in connection with the crowdsourcing platform over the network 118. In an embodiment, the second processor 502 may submit the processing report of the worker to the crowdsourcing platform over the network 118. The processing report may be utilized by the first processor 302 to either upgrade or degrade the worker's performance rating. An example of the user-interfaces that may be presented to the worker during the selection and processing of the one or more tasks is discussed in conjunction with FIGS. 7A, 7B, 7C, and 7D.

FIGS. 7A, 7B, 7C, and 7D illustrate example graphical user interfaces 700A, 700B, 700C, and 700D, respectively, which may be presented to the worker on the worker-computing device 116, in accordance with at least one embodiment.

As shown in FIG. 7A, the graphical user interface (GUI) 700A displays a crowdsourcing platform task selection portal 702 that may be presented to the one or more workers. In an embodiment, a number of new tasks (denoted by 704) may be displayed within the crowdsourcing platform task selection portal 702. The GUI 700A may allow the one or more workers to select the one or more tasks of his/her preferences using a selector 712, while the worker-computing device 116 is connected to the crowdsourcing platform over the network 118. In an embodiment, the worker may opt for the recurrence of the one or more tasks using a recurrence tab 710. In an embodiment, the worker may utilize a time duration tab 708 to provide the time duration or time period during the course of the day, during which the worker may accept recurring tasks from the crowdsourcing platform.

As shown in FIG. 7B, the GUI 700B displays a task processing platform 714 that may be presented to the one or more workers such as a worker A on the worker-computing device 116, while the worker-computing device 116 is disconnected from the crowdsourcing platform. The worker A may utilize a processing portal 716 to process the one or more tasks. In an embodiment, the GUI 700B may display the second expiry time associated with the one or more tasks (denoted by 718). In an embodiment, the GUI 700B may display a second timer (denoted by 720) that may keep a track of the time elapsed during the processing of the one or more tasks. For example, the worker A processes a first task on the processing portal 716 as shown in FIG. 7B. The second expiry time associated with the first task is 5 hours. As shown in FIG. 7B, the time available for completing the first task is 3 hours. In such a scenario, the worker A continue to process the first task on the worker-computing device 116 till the second expiry time associated with the first task expires.

The GUI 700C displays a scenario, where the worker A has not completed the first task and the second expiry time associated with the first tasks has expired. In such a case, a pop-up such as task processing blocked (depicted by 722) appears on the GUI 700C (on the worker-computing device 116) as shown in FIG. 7C. Post the expiry of the second expiry time associated with the first task, the worker A may not be able to process the first task on the worker-computing device 116. In such a scenario, the performance rating of the worker A may be degraded and the first task may be assigned to other workers with a fresh second expiry time.

Further, there might be a case, where the worker has completed the first task on or before the second expiry time. For example, the GUI 700D displays a scenario, where the worker A has completed and submitted the first task before second expiry time. In such a case, a second task may be transmitted on the worker-computing device 116 (when the worker has selected for recurrence of tasks), when the worker-computing device 116 is connected with the crowdsourcing platform over the network 118 and a pop-up such as new task available (depicted by 724) may appear on the GUI 700D.

Various embodiments of the disclosure lead to a method and a system that enables the offline processing of the one or more tasks on the worker's system. The system consists of two agents namely, a task selection agent and a task deploying agent. The task selection agent enables a worker to select the one or more tasks from the crowdsourcing platform over the network. The one or more tasks are transmitted to the worker's system that fulfill the worker's preference criteria and have expiry time that accommodate the worker's availability for executing the one or more tasks, when the worker's system is disconnected from the crowdsourcing platform. Additionally, such a system addresses the issue of limited or poor internet connectivity in developing markets where a major part of the crowdsourcing labor exists.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C,” “C++,” “Visual C++,” Java, and “Visual Basic.” Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for processing the one or more tasks have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for processing one or more tasks, said method comprising:
in a crowdsourcing platform:
transmitting, by one or more processors, said one or more tasks to a worker computing device, wherein a worker associated with said worker computing device processes said one or more tasks, while said worker computing device is disconnected from said crowdsourcing platform; and
receiving, by said one or more processors, responses for said one or more tasks from said worker computing device, wherein said worker computing device connects to said crowdsourcing platform for submitting said responses.

2. The method of claim 1, wherein said one or more tasks are selected by said worker when said worker computing device is connected with said crowdsourcing platform.

3. The method of claim 1, wherein each of said one or more tasks has an associated first expiry time.

4. The method of claim 3 further comprising defining, by said one or more processors, a second expiry time for each of said one or more tasks, wherein said second expiry time is less than said first expiry time.

5. The method of claim 4, wherein said second expiry time corresponds to a timestamp before which said worker has to submit said responses for said one or more tasks.

6. The method of claim 4 further comprising checking, by said one or more processors, whether said second expiry time has expired.

7. The method of claim 6, wherein said one or more tasks are unavailable for workers other than said worker before expiration of said second expiry time.

8. A method for processing one or more tasks, said method comprising:
in a worker computing device:
monitoring, by one or more processors, said worker computing device for at least security threats;
receiving, by said one or more processors, said one or more tasks from a crowdsourcing platform based on said monitoring of said worker computing device, wherein said one or more tasks are processed by a worker on said worker computing device, while said worker computing device is disconnected from said crowdsourcing platform;
monitoring, by said one or more processors, said processing of said one or more tasks by said worker; and
transmitting, by said one or more processors, responses for said one or more tasks to said crowdsourcing platform from said worker computing device based on said monitoring of said one or more tasks, wherein said worker computing device connects to said crowdsourcing platform for submitting said responses.

9. The method of claim 8, wherein each of said one or more tasks has an associated second expiry time, wherein said second expiry time corresponds to a timestamp before which said worker has to submit said responses to said crowdsourcing platform.

10. The method of claim 9, wherein said monitoring of said processing of said one or more tasks comprises checking if said second expiry time has expired.

11. The method of claim 10 further comprising presenting, by said one or more processors, a notification to said worker about expiration of said second expiry time.

12. The method of claim 10, wherein said monitoring of said processing of said one or more tasks further comprises monitoring a count of attempted tasks from one or more tasks.

13. The method of claim 10 further comprising transmitting, by said one or more processors, a report of said processing of said one or more tasks to said crowdsourcing platform, when said worker computing device connects to said crowdsourcing platform.

14. The method of claim 8 further comprising checking, by said one or more processors, said responses for security threats.

15. A crowdsourcing platform for processing one or more tasks, said crowdsourcing platform comprising:
one or more processors configured to:
transmit said one or more tasks to a worker computing device, wherein a worker associated with said worker computing device processes said one or more tasks, while said worker computing device is disconnected from said crowdsourcing platform; and
receive responses for said one or more tasks from said worker computing device, wherein said worker computing device connects to said crowdsourcing platform for submitting said responses.

16. The crowdsourcing platform of claim 15, wherein said one or more tasks are selected by said worker when said worker computing device is connected with said crowdsourcing platform.

17. The crowdsourcing platform of claim 15, wherein said one or more processors are further configured to check whether a second expiry time has expired, wherein each of said one or more tasks is associated with a first expiry time and said second expiry time, wherein said second expiry time is less than said first expiry time.

18. The crowdsourcing platform of claim 17, wherein said one or more tasks are unavailable for workers other than said worker before expiration of said second expiry time.

19. A worker computing device for processing one or more tasks, said worker computing device comprising:
one or more processors configured to:
monitor said worker computing device for at least security threats;
receive said one or more tasks from a crowdsourcing platform based on said monitoring of said worker computing device, wherein said one or more tasks are processed by a worker on said worker computing device, while said worker computing device is disconnected from said crowdsourcing platform;
monitor said processing of said one or more tasks by said worker; and
transmit responses for said one or more tasks to said crowdsourcing platform from said worker computing device based on said monitoring of said one or more tasks, wherein said worker computing device connects to said crowdsourcing platform for submitting said responses.

20. The worker computing device of claim 19, wherein each of said one or more tasks has an associated second expiry time, wherein said second expiry time corresponds to a timestamp before which said worker has to submit said responses to said crowdsourcing platform.

21. The worker computing device of claim 20, wherein said monitoring of said processing of said one or more tasks by said worker further comprises checking if said second expiry time has expired.

22. The worker computing device of claim 21, wherein said one or more processors are further configured to present a notification to said worker about expiration of said second expiry time.

23. The worker computing device of claim 21, wherein said monitoring of said processing of said one or more tasks further comprises monitoring a count of attempted tasks from one or more tasks.

24. The worker computing device of claim 21, wherein said one or more processors are further configured to transmit a report of said processing of said one or more tasks to said crowdsourcing platform, when said worker computing device connects to said crowdsourcing platform.

25. The worker computing device of claim 19, wherein said one or more processors are further configured to check said responses for security threats.

26. A computer program product for use with a computer, the computer program product comprising a non-transitory computer readable medium, wherein the non-transitory computer readable medium stores a computer program code for processing one or more tasks in a crowdsourcing platform, wherein the computer program code is executable by one or more processors to:
transmit said one or more tasks to a worker computing device, wherein a worker associated with said worker computing device processes said one or more tasks, while said worker computing device is disconnected from said crowdsourcing platform; and
receive responses for said one or more tasks from said worker computing device, wherein said worker computing device connects to said crowdsourcing platform for submitting said responses.

27. A computer program product for use with a computer, the computer program product comprising a non-transitory computer readable medium, wherein the non-transitory computer readable medium stores a computer program code for processing one or more tasks in a worker computing device, wherein the computer program code is executable by one or more processors to:
monitor said worker computing device for at least security threats;
receive said one or more tasks from a crowdsourcing platform based on said monitoring of said worker computing device, wherein said one or more tasks are processed by a worker on said worker computing device, while said worker computing device is disconnected from said crowdsourcing platform;
monitor said processing of said one or more tasks by said worker; and
transmit responses for said one or more tasks to said crowdsourcing platform from said worker computing device based on said monitoring of said one or more tasks, wherein said worker computing device connects to said crowdsourcing platform for submitting said responses.
